(19) United States
(12) Patent Application Publication
(10) Pub. No.: US 2007/0294314 A1
(43) Pub. Date: Dec. 20, 2007

(54) Bitmap based synchronization

(76) Inventors: Michael Padovano, Bridgewater, NJ (US); Michael G. Byrnes, Bridgewater, NJ (US); Charles E. Christian, Bridgewater, NJ (US); Laura Clemens, Colorado Springs, CO (US); Rodger Daniels, Boise, ID (US); Deborah Levinson, Colorado Springs, CO (US); Susan Spence, Palo Alto, CA (US); Christopher Stroberger, Colorado Springs, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/454,755

(22) Filed: Jun. 16, 2006

(51) Int. Cl. G06F 17/30

(52) U.S. Cl. 707/201

(57) ABSTRACT

In one embodiment, a method for bitmap based synchronization of a source volume and a target volume comprises obtaining, in a source controller, a synchronization timestamp, and for one or more bits in a bitmap representing the source volume, transmitting a synchronization request to the target volume, wherein the synchronization request comprises the synchronization timestamp, receiving a reply from the target volume, and clearing the bit in the bitmap in response to the reply from the target volume.

### BACKGROUND

The described subject matter relates to electronic computing, and more particularly to bitmap based synchronization.

Effective collection, management, and control of information have become a central component of modern business processes. To this end, many businesses, both large and small, now implement computer-based information management systems.

Data management is an important component of computer-based information management systems. Many users implement storage networks to manage data operations in computer-based information management systems. Storage networks have evolved in computing power and complexity to provide highly reliable, managed storage solutions that may be distributed across a wide geographic area.

The ability to duplicate and store the contents of a storage device is an important feature of a storage system. A storage device or network may maintain redundant copies of data to safeguard against the failure of a single storage device, medium, or communication connection. Upon a failure of the first storage device, medium, or connection, the storage system may then locate and/or retrieve a copy of the data contained in a second storage device or medium. The ability to duplicate and store the contents of the storage device also facilitates the creation of a fixed record of contents at the time of duplication. This feature allows users to recover a prior version of inadvertently edited or erased data.

Redundant copies of data records require synchronization on at least a periodic basis. Data synchronization can be a resource-intensive process. Hence, adroit management of data synchronization processes contributes to efficient operations.

### SUMMARY

In one embodiment, a method for bitmap based synchronization of a source volume and a target volume comprises obtaining, in a source controller, a synchronization timestamp, and, for one or more bits in a bitmap representing the source volume: transmitting a synchronization request to the target volume, wherein the synchronization request comprises the synchronization timestamp, receiving a reply from the target volume, and clearing the bit in the bitmap in response to the reply from the target volume.

### BRIEF DESCRIPTION OF THE DRAWINGS

FIG. 1 is a schematic illustration of an exemplary embodiment of a storage network environment.

FIG. 2 is a schematic illustration of an exemplary embodiment of an array controller.

FIG. 3 is a schematic illustration of an exemplary embodiment of a data architecture that may be implemented in a storage device.

FIG. 4 is a schematic illustration of a storage architecture utilized to manage data replication operations in accordance with an embodiment.

FIG. 5 and FIG. 6 are flowcharts illustrating operations in a method for implementing bitmap based synchronization operations in a storage network in accordance with an embodiment.

FIGS. 7-11 are schematic illustrations of data sets in accordance with an embodiment.

### DETAILED DESCRIPTION

Described herein are exemplary systems and methods for implementing bitmap based synchronization in a storage device, array, or network. The methods described herein may be embodied as logic instructions on a computer-readable medium. When executed on a processor such as, e.g., a disk array controller, the logic instructions cause the processor to be programmed as a special-purpose machine that implements the described methods. The processor, when configured by the logic instructions to execute the methods recited herein, constitutes structure for performing the described methods. The methods will be explained with reference to one or more logical volumes in a storage system, but the methods need not be limited to logical volumes. The methods are equally applicable to storage systems that map to physical storage, rather than logical storage.

### Exemplary Storage Network Architectures

In one embodiment, the subject matter described herein may be implemented in a storage architecture that provides virtualized data storage at a system level, such that virtualization is implemented within a storage area network (SAN), as described in published U.S. Patent Application Publication No. 2003/0079102 to Lubbers, et al., the disclosure of which is incorporated herein by reference in its entirety.

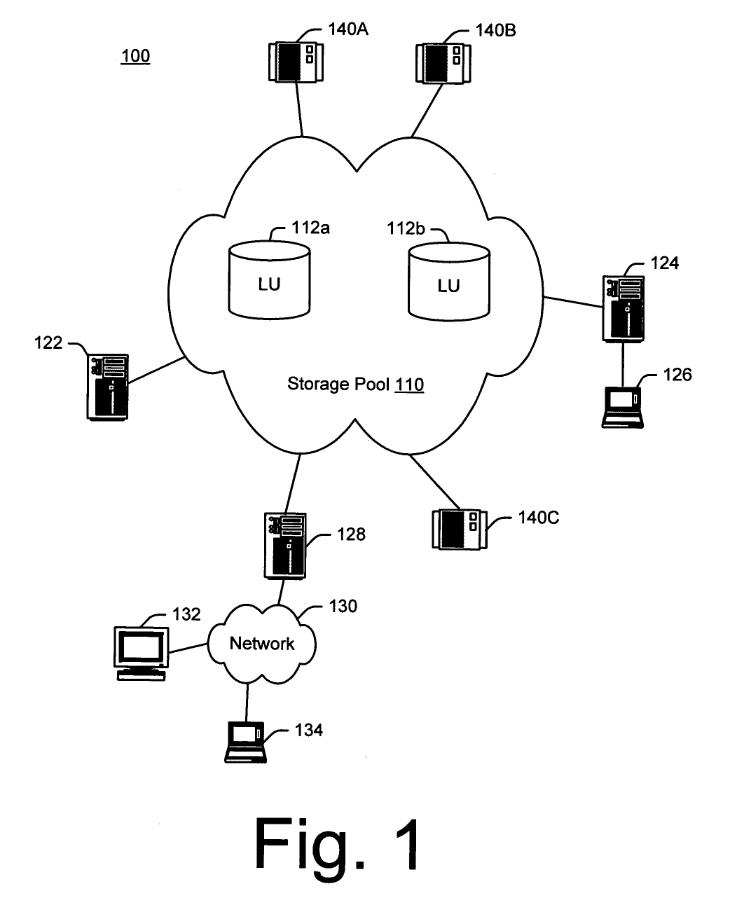

FIG. 1 is a schematic illustration of an exemplary implementation of a networked computing environment 100. Referring to FIG. 1, computing environment 100 includes a storage pool 110 that provides data storage services to one or more computing devices. Storage pool 110 may be implemented in one or more networked storage cells 140A, 140B, 140C. Exemplary storage cells include the STORAGEWORKS line of storage devices commercially available from Hewlett-Packard Corporation of Palo Alto, Calif., USA. Storage cells 140A, 140B, 140C may be co-located or may be geographically distributed, and may be connected by a suitable communication network. The communication network may be embodied as a private, dedicated network such as, e.g., a Fibre Channel (FC) switching fabric. Alternatively, portions of the communication network may be implemented using public communication networks pursuant to a suitable communication protocol such as, e.g., the Internet Small Computer Serial Interface (iSCSI) protocol. The number of storage cells 140A, 140B, 140C that can be included in any storage network is limited primarily by the connectivity implemented in the communication network. For example, a switching fabric comprising a single FC switch can interconnect 256 or more ports, providing a possibility of hundreds of storage cells in a single storage network.

Computing environment 100 further includes one or more host computing devices which utilize storage services provided by the storage pool 110 on their own behalf or on behalf of other client computing or data processing systems or devices. Client computing devices such as client 126 access storage the storage pool 110 embodied by storage cells 140A, 140B, 140C through a host computer. For example, client computer 126 may access storage pool 110 via a host such as server 124. Server 124 may provide file services to client 126, and may provide other services such as transaction processing services, email services, etc. Host computer 122 may also utilize storage services provided by storage pool 110 on its own behalf. Clients such as clients 132, 134 may be connected to host computer 128 directly, or via a network 130 such as a Local Area Network (LAN) or a Wide Area Network (WAN).

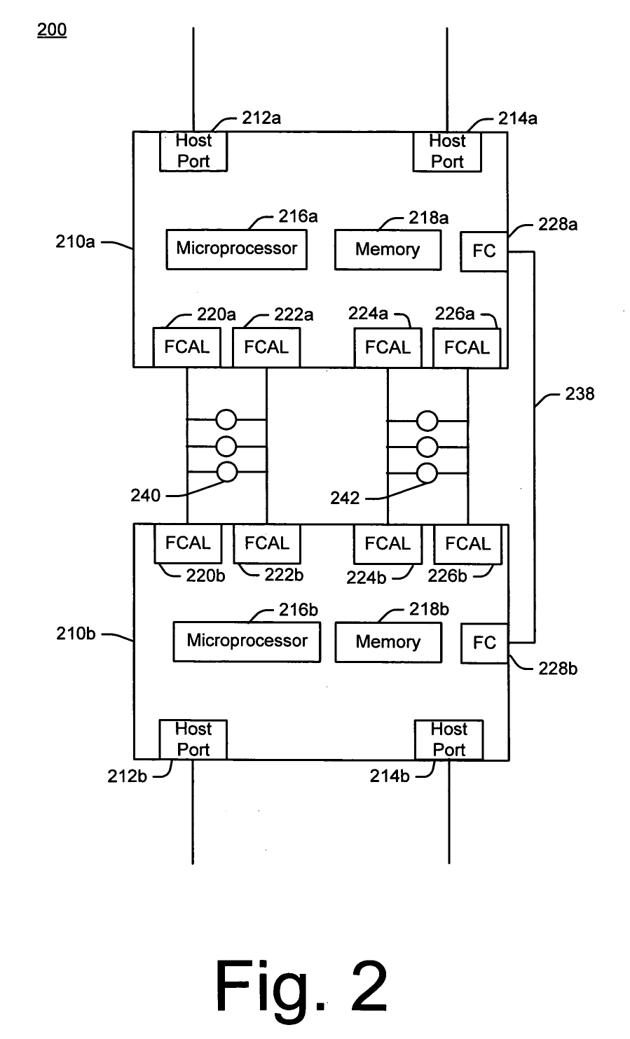

FIG. 2 is a schematic illustration of an exemplary embodiment of a storage cell 200. Storage cell 200 may correspond to one of the storage cells 140A, 140B, 140C depicted in FIG. 1. It will be appreciated that the storage cell 200 depicted in FIG. 2 is merely one exemplary embodiment, which is provided for purposes of explanation.

Referring to FIG. 2, storage cell 200 includes two Network Storage Controllers (NSCs), also referred to as “disk array controllers” or just “array controllers” 210a, 210b to manage operations and the transfer of data to and from one or more sets of disk drives 240, 242. Array controllers 210a, 210b may be implemented as plug-in cards having a microprocessor 216a, 216b, and memory 218a, 218b. Each array controller 210a, 210b includes dual host adapter ports 212a, 214a, 212b, 214b that provide an interface to a host, i.e., through a communication network such as a switching fabric. In a Fibre Channel implementation, host adapter ports 212a, 212b, 214a, 214b may be implemented as FC N_Ports. Each host adapter port 212a, 212b, 214a, 214b manages the login and interface with a switching fabric, and is assigned a fabric-unique port ID in the login process. The architecture illustrated in FIG. 2 provides a fully-redundant storage cell. This redundancy is entirely optional; only a single array controller is required to implement a storage cell.

Each array controller 210a, 210b further includes a communication port 228a, 228b that enables a communication connection 238 between the array controllers 210a, 210b. The communication connection 238 may be implemented as a FC point-to-point connection, or pursuant to any other suitable communication protocol.

In an exemplary implementation, array controllers 210a, 210b further include a plurality of Fiber Channel Arbitrated Loop (FCAL) ports 220a-226a, 220b-226b that implements an FCAL communication connection with a plurality of storage devices, e.g., sets of disk drives 240, 242. While the illustrated embodiment implement FCAL connections with the sets of disk drives 240, 242, it will be understood that the communication connection with sets of disk drives 240, 242 may be implemented using other communication protocols. For example, rather than an FCAL configuration, a FC switching fabric may be used.

In operation, the storage capacity provided by the sets of disk drives 240, 242 may be added to the storage pool 110. When an application requires storage capacity, logic instructions on a host computer such as host computer 128 establish a LUN from storage capacity available on the sets of disk drives 240, 242 available in one or more storage sites. It will be appreciated that, because a LUN is a logical unit, not a physical unit, the physical storage space that constitutes the LUN may be distributed across multiple storage cells. Data for the application may be stored on one or more LUNs in the storage network. An application that needs to access the data queries a host computer, which retrieves the data from the LUN and forwards the data to the application.

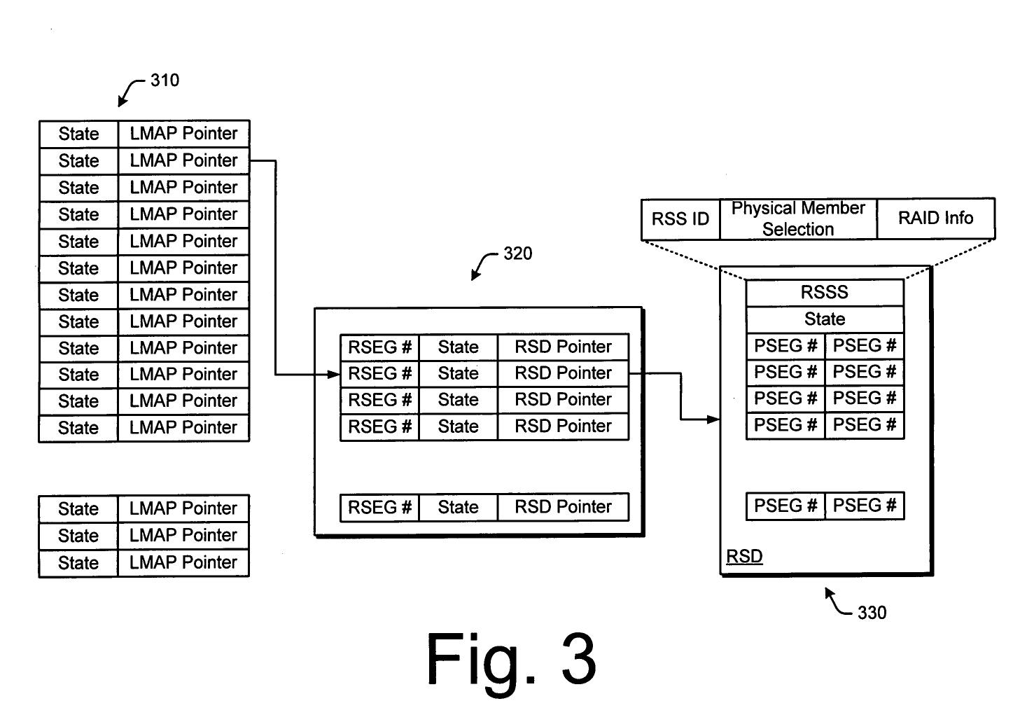

FIG. 3 is a schematic illustration of an example memory representation of a logical unit such as logical units 112a, 112b in accordance with an embodiment. As used herein, the term “memory representation” refers to a mapping structure that may be implemented in memory of a controller that enables translation of a request expressed in terms of a logical block address (LBA) from host 128 into a read/write command addressed to a particular portion of a physical disk having the desired information.

The memory representation enables each logical unit 112a, 112b to implement from 1 Mbyte to 2 TByte of physical storage capacity. Larger storage capacities per logical unit may be implemented. Further, the memory representation enables each logical unit to be defined with any type of RAID data protection, including multi-level RAID protection, as well as supporting no redundancy. Moreover, multiple types of RAID data protection may be implemented within a single logical unit such that a first range of logical disk addresses (LDAs) correspond to unprotected data, and a second set of LDAs within the same logical unit implement RAID 5 protection.

A persistent copy of a memory representation illustrated in FIG. 3 is maintained for logical units such as logical units 112a, 112b in a metadata container referred to herein as a primary logical disk metadata container (PLDMC). A LUN such as LUN 112a, 112b comprises one or more redundant stores (RStore) which are a fundamental unit of reliable storage. An RStore, in turn, comprises an ordered set of physical storage segments (PSEGs) with associated redundancy properties and is contained entirely within a single redundant store set (RSS). By analogy to conventional storage systems, PSEGs are analogous to disk drives and each RSS is analogous to a RAID storage set comprising a plurality of drives.

The PSEGs that implement a particular LUN may be spread across any number of physical storage disks. Moreover, the physical storage capacity that a particular LUN represents may be configured to implement a variety of storage types offering varying capacity, reliability and availability features. For example, some LUNs may represent striped, mirrored and/or parity-protected storage. Other LUNs may represent storage capacity that is configured without striping, redundancy or parity protection.

A logical disk mapping layer maps a LDA specified in a request to a specific RStore as well as an offset within the RStore. Referring to the embodiment shown in FIG. 3, the present invention is implemented using an L2MAP 310, an LMAP 320, and a redundancy set descriptor (RSD) 330 as the primary structures for mapping a logical disk address to physical storage location(s) represented by that address. The mapping structures shown in FIG. 3 may be implemented for each logical unit. A single L2MAP 310 handles the entire logical unit. Each logical unit is represented by multiple LMAPs 320 where the particular number of LMAPs 320 depends on the amount of address space that is allocated at any given time. RSDs 330 also exist only for allocated storage space. Using this split directory approach, a large storage volume that is sparsely populated with allocated storage, the structure shown in FIG. 3 efficiently represents the allocated storage while minimizing data structures for unallocated storage.

In one embodiment, L2MAP 310 includes a plurality of entries, each of which represents 2 Gbyte of address space. For a 2 Tbyte logical unit, therefore, L2MAP 310 includes 1024 entries to cover the entire address space in the particular example. Each entry may include state information relating to the corresponding 2 Gbyte of storage, and an LMAP pointer to a corresponding LMAP descriptor 320. The state information and LMAP pointer are set when the corresponding 2 Gbyte of address space have been allocated, hence, some entries in L2MAP 310 will be empty or invalid in many applications.

The address range represented by each entry in LMAP 320, is referred to as the logical disk address allocation unit (LDAAU). In one embodiment, the LDAAU is 1 MByte. An entry is created in LMAP 320 for each allocated LDAAU without regard to the actual utilization of storage within the LDAAU. In other words, a logical unit can grow or shrink in size in increments of 1 Mbyte. The LDAAU represents the granularity with which address space within a logical unit can be allocated to a particular storage task.

An LMAP 320 exists for each 2 Gbyte increment of allocated address space. If less than 2 Gbyte of storage are used in a particular logical unit, only one LMAP 320 is required, whereas, if 2 Tbyte of storage is used, 1024 LMAPs 320 will exist. Each LMAP 320 includes a plurality of entries, each of which may correspond to a redundancy segment (RSEG). An RSEG is an atomic logical unit that is analogous to a PSEG in the physical domain—akin to a logical disk partition of an RStore.

In one embodiment, an RSEG may be implemented as a logical unit of storage that spans multiple PSEGs and implements a selected type of data protection. Entire RSEGs within an RStore may be bound to contiguous LDAs. To preserve the underlying physical disk performance for sequential transfers, RSEGs from an RStore may be located adjacently and in order, in terms of LDA space, to maintain physical contiguity. If, however, physical resources become scarce, it may be necessary to spread RSEGs from RStores across disjoint areas of a logical unit. The logical disk address specified in a request selects a particular entry within LMAP 320 corresponding to a particular RSEG that in turn corresponds to 1 Mbyte address space allocated to the particular RSEG #. Each LMAP entry also includes state information about the particular RSEG #, and an RSD pointer.

Optionally, the RSEG #s may be omitted, which results in the RStore itself being the smallest atomic logical unit that can be allocated. Omission of the RSEG # decreases the size of the LMAP entries and allows the memory representation of a logical unit to demand fewer memory resources per MByte of storage. Alternatively, the RSEG size can be increased, rather than omitting the concept of RSEGs altogether, which also decreases demand for memory resources at the expense of decreased granularity of the atomic logical unit of storage. The RSEG size in proportion to the RStore can, therefore, be changed to meet the needs of a particular application.

In one embodiment, the RSD pointer points to a specific RSD 330 that contains metadata describing the RStore in which the corresponding RSEG exists. The RSD includes a redundancy storage set selector (RSSS) that includes a redundancy storage set (RSS) identification, a physical member selection, and RAID information. The physical member selection may include a list of the physical drives used by the RStore. The RAID information, or more generically data protection information, describes the type of data protection, if any, that is implemented in the particular RStore. Each RSD also includes a number of fields that identify particular PSEG numbers within the drives of the physical member selection that physically implement the corresponding storage capacity. Each listed PSEG # may correspond to one of the listed members in the physical member selection list of the RSSS. Any number of PSEGs may be included, however, in a particular embodiment each RSEG is implemented with between four and eight PSEGs, dictated by the RAID type implemented by the RStore.

In operation, each request for storage access specifies a logical unit such as logical unit 112a, 112b, and an address. A controller such as array controller 210A, 210B maps the logical drive specified to a particular logical unit, then loads the L2MAP 310 for that logical unit into memory if it is not already present in memory. Preferably, all of the LMAPs and RSDs for the logical unit are also loaded into memory. The LDA specified by the request is used to index into L2MAP 310, which in turn points to a specific one of the LMAPs. The address specified in the request is used to determine an offset into the specified LMAP such that a specific RSEG that corresponds to the request-specified address is returned. Once the RSEG # is known, the corresponding RSD is examined to identify specific PSEGs that are members of the redundancy segment, and metadata that enables a NSC 210A, 210B to generate drive specific commands to access the requested data. In this manner, an LDA is readily mapped to a set of PSEGs that must be accessed to implement a given storage request.

In one embodiment, the L2MAP consumes 4 Kbytes per logical unit regardless of size. In other words, the L2MAP includes entries covering the entire 2 Tbyte maximum address range even where only a fraction of that range is actually allocated to a logical unit. It is contemplated that variable size L2MAPs may be used, however such an implementation would add complexity with little savings in memory. LMAP segments consume 4 bytes per Mbyte of address space while RSDs consume 3 bytes per MB. Unlike the L2MAP, LMAP segments and RSDs exist only for allocated address space.

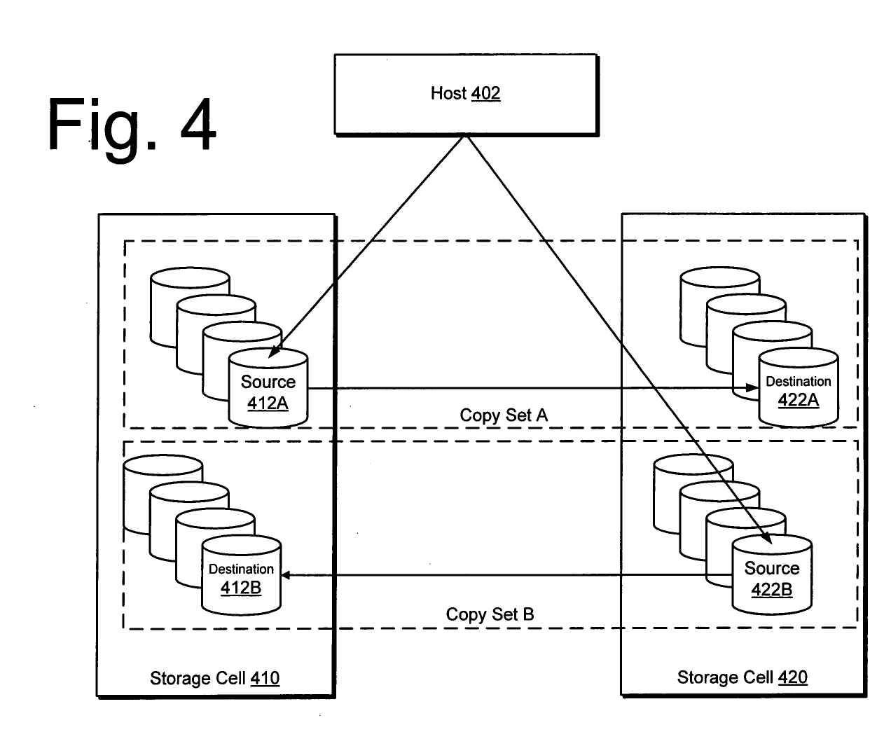

Storage systems may be configured to maintain duplicate copies of data to provide redundancy. Input/Output (I/O) operations that affect a data set may be replicated to redundant data set. FIG. 4 is a schematic illustration of a storage architecture utilized to manage data replication operations in accordance with an embodiment. In the embodiment depicted in FIG. 4, a storage cell such as storage cell 140A, 140B, 140C may be implemented at one or more sites of a storage network. One or more virtual disks, referred to as “source” disks or a “source volume,” are allocated within a first storage cell to handle input/output operations data with one or more hosts. Further, one or more virtual disks, referred to as “destination” disks or a “destination volume” (also referred to as “target” disks or volumes) are allocated within a second storage cell to execute data replication operations with the source virtual disks in the first storage cell.

In the embodiment depicted in FIG. 4, one or more virtual disks 412A in storage cell 410 may be designated as a source volume for I/O operations from host 402, and one or more virtual disks 422A functions as a destination for data replication operations for source virtual disks 412A. Source 412A and destination 422A define a copy set, designated in FIG. 4 as copy set A. Similarly, one or more virtual disks 422B in storage cell 420 may be designated as a source volume for I/O operations from host 402, and one or more virtual disks 412B functions as a destination for data replication operations for source virtual disks 422B. Source 422B and destination 412B define a copy set, designated in FIG. 4 as copy set B.

In normal operation, write operations from host 402 are directed to the designated source virtual disk 412A, 422B, and may be copied in a background process to one or more destination virtual disks 422A, 412B, respectively. A destination virtual disk 422A, 412B may implement the same logical storage capacity as the source virtual disk, but may provide a different data protection configuration. Controllers such as array controller 210A, 210B at the destination storage cell manage the process of allocating memory for the destination virtual disk autonomously. In one embodiment, this allocation involves creating data structures that map logical addresses to physical storage capacity, as described in greater detail in published U.S. Patent Application Publication No. 2003/0084241 to Lubbers, et al., the disclosure of which is incorporated herein by reference in its entirety.

To implement a copy transaction between a source and destination, a communication path between the source and the destination sites is determined and a communication connection is established. The communication connection need not be a persistent connection, although for data that changes frequently, a persistent connection may be efficient. A. heartbeat may be initiated over the connection. Both the source site and the destination site may generate a heartbeat on each connection. Heartbeat timeout intervals may be adaptive based, e.g., on distance, computed round trip delay, or other factors.

### Bitmap Based Synchronization

In some embodiments, a storage system as described with reference to FIGS. 1-4 may be configured to implement a bitmap based synchronization scheme which utilizes a combination of timestamps and a bitmap to enable a source storage volume to handle input/output operations contemporaneous with synchronization operations.

### Timestamp Assignment

In one embodiment, a controller in a storage system may implement a timestamp mechanism that imposes agreement on the ordering of a write request. For example, a controller may store two timestamps per block: an order timestamp (ordTs), which is the time of the last attempted update; and a value timestamp (valTs), which is the time that the value was stored.

The timestamps may be used to prevent simultaneous write requests from overwriting each other, and the storage controller uses them when blocks are updated. For example, when a host issues a write request, the storage system runs that write request in two phases: an order phase and a write phase.

The order phase takes the current time as a parameter, and succeeds only if the current time is greater than the ordTs and the valTs associated with the block, as shown in Table 1:

TABLE 1

```
Order(newTs) {
    if (newTs > ordTs) && (newTs >
valTs)) {
        ordTs = newTs;
        return success;
    } else
        return failure;
}
```

The write phase takes as parameters the current time and the data to be written, and succeeds only if the current time is greater than or equal to the ordTs and greater than the valTs associated with the blocks, as shown in Table 2:

TABLE 2

```
Write(newTs, newVal) {
    if (newTs ≧ordTs) && (newTs > valTs) {
        valTs = newTs;
        write newVal to blocks;
        return success;
    } else
        return failure
}
```

Thus, the ordTs and the valTs implement an agreement on write ordering. When a controller updates the ordTs for a block, it promises that no older write requests will be accepted, although a newer one can be accepted. Additionally, the valTs indicates the value itself has been updated. So, if the order phase or the write phase fails during a write operation, then newer data to the same blocks has been written by another controller. In that case, the controller initiating the first write request must retry the request with a higher timestamp.

Because the timestamps capture an agreement on ordering, a synchronization algorithm may use the timestamps to order synchronization requests and host write requests. The following paragraphs present a brief explanation of a technique for a synchronous replication mechanism, according to an embodiment.

### Synchronous Remote Replication

In one embodiment, a remote replication technique may implement an order and write phase with synchronous replication. For synchronous replication, a write request to a source virtual disk may be implemented using the following technique, which is illustrated in pseudo-code in Table 3.

TABLE 3

```
status = unknown
while (status != success) {
    currTs = current time;
    If (moduleLocal.Order(currTs)) == failure) {
            status = failure;
            continue;
    }
    If (moduleLocal.Write(currTs, data) == failure ||
        moduleRemote.Write(currTs, data) == failure) {
            status = failure;
            continue;
    }
    status = success;
}
```

Initially, a source controller obtains a timestamp and issues an order phase to a local module (e.g., a local storage cell management module). As shown in Table 1 above, the local module returns success only if the given timestamp is larger (i.e., more recent in time) than the ordTs for the blocks. If the local module returns failure because the timestamp was less than or equal to (i.e., less recent in time) the ordTs of the blocks, then the controller issues a new order phase with a new timestamp.

If the local module returns success, the controller issues the write phase to both the local module and a remote module (e.g., a remote storage cell management module). The local module controller performs the write phase as described in Table 2 above.

The remote module software sends a network request to the destination storage cell. The network request contains the timestamp provided by the source controller, along with data to be written to the target virtual disk. A controller in the target storage system performs both the order phase and the write phase on the target virtual disk. If both phases succeed, the target storage system returns a successful status to the remote module on the source storage system. If either the order phase or the write phase fails, the target storage system returns a failure status to the remote module on the source storage system.

At the source storage system, if either the local module or the remote module return failure, then either a newer write request arrived at the local virtual disk before the current write was able to be completed or a newer write request arrive at the remote virtual disk before the current write could be completed. In either case, the source controller may retry the process from the beginning, using a new timestamp.

As described above, the remote module sends a network request to the target storage system. The network request contains the timestamp provided by the upper layer, along with the data to be written to the target virtual disk. Table 4 is a high-level illustration of the algorithm at the target storage system.

TABLE 4

read currTs and data from source storage cell;
status = moduleLocal.Order(currTs);
if (status == failure)
return failure to source storage cell;
status = moduleLocal.Write(currTs, data);
return status to source storage cell;

### Bitmap-Based Synchronization Algorithm

A storage system may implement a bitmap-based synchronization algorithm that allows hosts to continue writing to the source volume(s) and destination volume(s) without requiring locking or serialization. In one embodiment, a storage system may utilize the ordTs and the valTs timestamps to implement a bitmap-based synchronization process.

A bitmap may be used to track whether I/O operations that change the contents of a volume have been executed against a volume. The granularity of the bitmap is essentially a matter of design choice. For example, a storage controller may maintain a bitmap that maps to individual data blocks such as, e.g., logical block addresses in a volume. Alternatively, a bitmap may map to groups of data blocks in a volume. In one embodiment, a bitmap may be embodied as an array of data fields that are assigned a first value (e.g., 0) to indicate that an I/O operation has not been executed against a volume or a second value (e.g., 1) to indicated that an I/O operation has been executed against a volume.

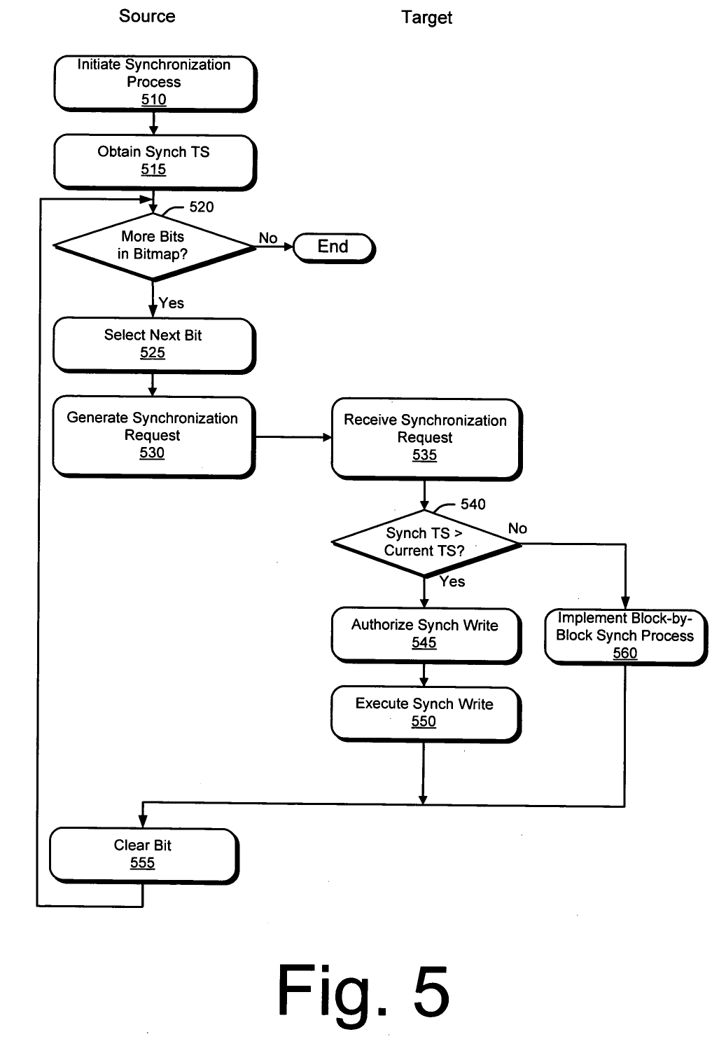

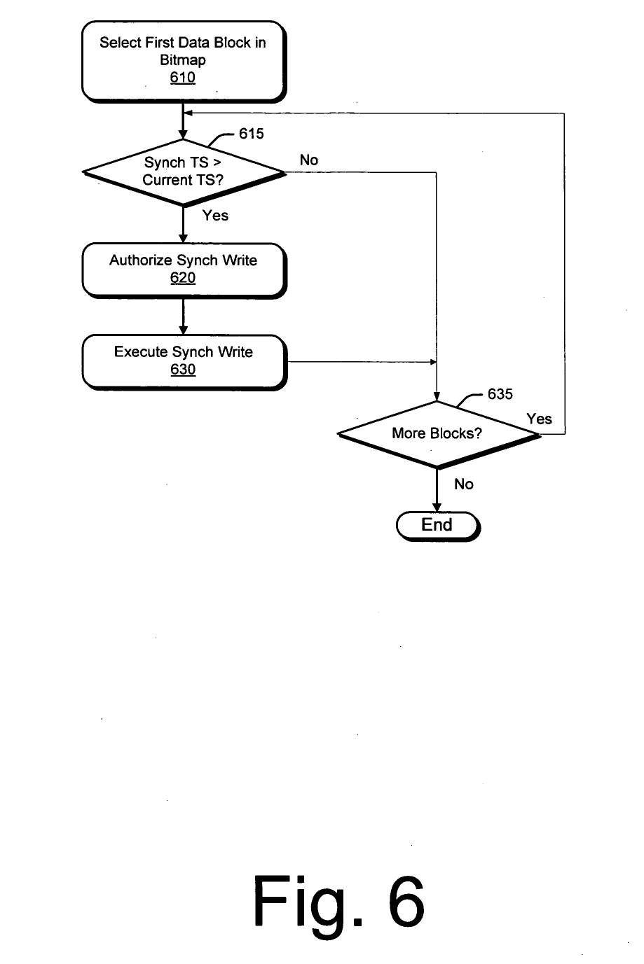

FIG. 5 and FIG. 6 are flowcharts illustrating operations in a method for bitmap based synchronization according to some embodiments. At operation 510 a synchronization process is initiated. When synchronization begins, write requests from hosts to the source volume may continue normally, while the source volume implements synchronous remote replication processing techniques as described above. Before hosts begin the normal synchronous remote replication processing, the source storage system starts a synchronization thread.

At operation 515 the synchronization thread obtains a timestamp for the synchronization process (Synch TS). In some embodiments, the timestamp may represent the current time, and that timestamp is used by the synchronization thread for the entire synchronization process. In some embodiments, the synchronization thread waits a small amount of time before it begins processing, ensuring that synchronization timestamp is older in time than any new timestamps obtained by write requests from hosts.

The synchronization thread reads the bitmap, and, if, at operation 520, there are no more bits in the bitmap, then the process may end. By contrast, if there are more bits in the bitmap, then at operation 520 the next bit in the bitmap is selected and at operation 530 a synchronization request is generated for the bit in the bitmap. In some embodiments, the synchronization request may include the data in the data blocks and the time stamps associated with the selected bit in the bitmap. In other embodiments, the synchronization request may omit the data and may only include the timestamps with the synchronization request. The synchronization request may be transmitted to the target storage cell.

At operation 535 the synchronization request is received by a processor such as, e.g., a storage controller, in the target storage cell. If, at operation 540 the Synch TS is greater than (i.e., later in time than) the timestamp associated with the corresponding data block(s) on the target storage cell, then control passes to operation 545 and a synchronization write operation is authorized on the target storage cell. If the data from the source storage cell was transmitted with the synchronization request, then at operation 550 a synchronization write operation may be executed, overwriting the data in the target storage cell with the data from the source storage cell.

At operation 555 the bit in the bitmap may be cleared. By contrast, if the data from the source storage cell was not included with the synchronization request, then the data may be transferred from the source storage cell to the target storage cell to execute the synchronization write operation.

By contrast, if at operation 540 the synchronization timestamp is not greater than the timestamp associated with the corresponding data block on the target storage cell, then control passes to operation 560 and a block-by-block synchronization process is implemented for the data blocks represented by the bitmap.

FIG. 6 is a flowchart illustrating operations in one embodiment of a block-by-block synchronization process. Referring to FIG. 6, at operation 610 the first data block in the bitmap is selected. If, at operation 615, the Synch TS is greater than (i.e., later in time than) the timestamp associated with the corresponding data block on the target storage cell, then control passes to then control passes to operation 620 and a synchronization write operation is authorized on the corresponding block in the target storage cell. If the data from the source storage cell was transmitted with the synchronization request, then at operation 630 a synchronization write operation may be executed, overwriting the data in the target storage cell with the data from the source storage cell. By contrast, if the data from the source storage cell was not included with the synchronization request, then the data may be transferred from the source storage cell to the target storage cell to execute the synchronization write operation.

By contrast, if at operation 615 the synchronization timestamp is not greater than the timestamp associated with the corresponding data block on the target storage cell, then control passes to operation 635. If, at operation 635, there are more blocks in the bitmap, then control passes back to operation 615. By contrast, if there are no further blocks in the bitmap, then the block-by-block synchronization process may end.

Thus, the operations of FIGS. 5-6 enable a source storage cell to implement a bitmap based synchronization process with a target storage cell. In embodiments, each bit in the bitmap may represent multiple data blocks in the source volume. Because the synchronization thread performs write requests to the target storage cell with a timestamp of Synch TS, and new write requests from hosts are performing write requests to the target storage cell with later timestamps, the synchronization thread will not overwrite any new data from hosts.

Various operational scenarios can occur. For example, if the synchronization thread issues a write request to the target storage cell in which data has not been updated by a host, then the write request will succeed on the target storage cell, and the storage cell will set both the ordts and valTs to the Synch Ts.

If a host issues a write request for an area of the source virtual disk that has no bit associated with it, then the write request will succeed on the target storage cell, and the target storage cell will set ordTs and valTs to the time that the local write occurred.

If a host issues a write request for an area of the source virtual disk after a bit has been cleared by the synchronization thread, then the write request will succeed on the target storage cell (since all writes that occur after the synchronization thread starts have a timestamp greater than Synch Ts), and the target storage cell will set ordTs and valTs to the time that the local write occurred.

If a host issues a write request for an area of the source volume that has a bit set but for which the synchronization thread has not yet processed, then the write request will succeed on the target storage cell. When the synchronization thread processes that area, then the timestamp of the remote block will be greater than the synchronization timestamp (synch TS), causing the write from the synchronization thread to fail. So, the target volume will correctly have the newer data.

If a host issues a write request for an area of the source virtual disk that has a bit set, and, at the same time, the synchronization thread processes that area, then the synchronization thread will send synch Ts to the target storage cell and the local thread will send the current time to the target storage cell. Because the current time is greater that Synch Ts, the synchronization thread will fail and the local write request will succeed, causing the correct data to be written.

However, as shown in FIG. 6, when the synchronization thread sends data to the target storage cell, the processing on the target storage cell varies slightly from the algorithm presented in Table 4. For example, certain actions may be taken if a local write updates data that is smaller than the data size associated with a bit in the bitmap.

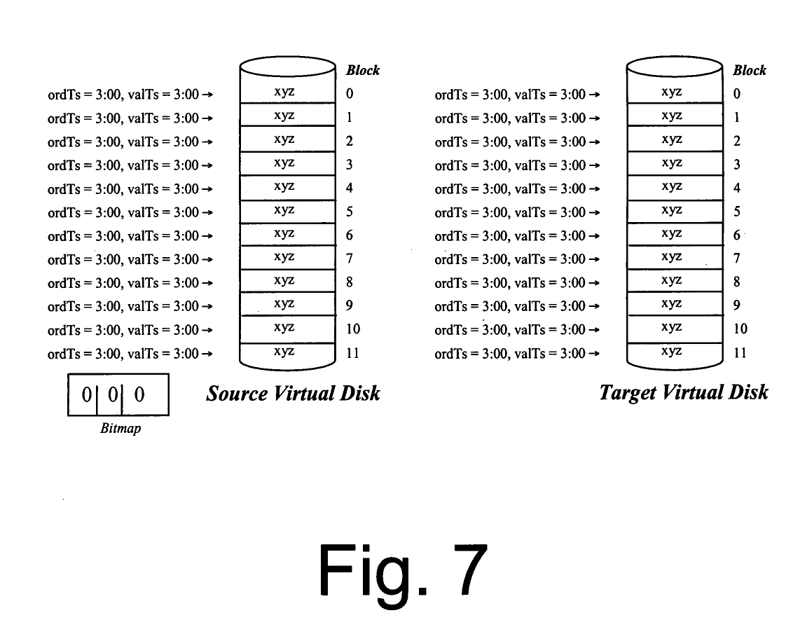

One example is presented in FIG. 7. FIGS. 7-11 are schematic illustration of one embodiment of a source volume (i.e., virtual disk) and a target volume (i.e., virtual disk). Each bit in the bitmap represents 4 blocks of data. Thus, bit 0 represents blocks 0 though 3, bit 2 represents blocks 4 through 7, and bit 3 represents blocks 8 through 11. In the embodiment depicted in FIG. 7 the source volume and the target volume are synchronized. Because the local volume and the remote virtual disk are synchronized, no bits in the bitmap are set and the timestamps for the source volume and the target volume are synchronized (to 3:00 in the embodiment depicted in FIG. 7).

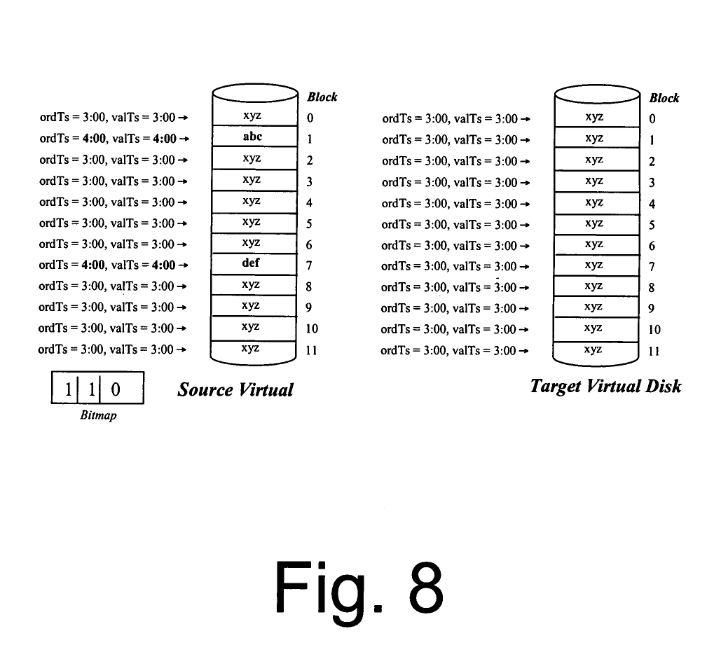

In the event that the network goes down the bitmap may be used to track changes made to the source virtual disk. For example, assume that at 4:00 PM, a host writes to block 1 (causing bit 1 in the bitmap to be set) and block 7 (causing bit 2 in the bitmap to be set). Thus, as described in above, the the ordTs and valTs of block 1 and block 7 will be updated on the source volume. FIG. 8 shows the system after the write operations take place.

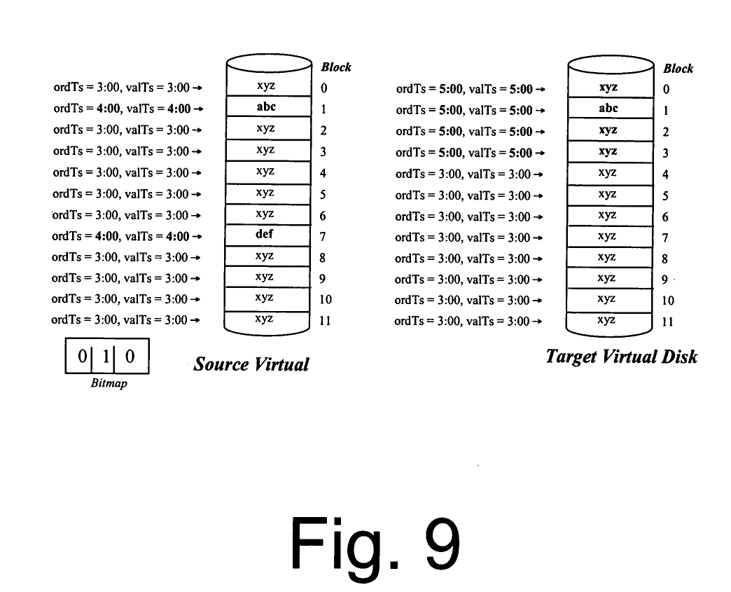

When the network comes back up the synchronization thread starts. For this example, assume that the synchronization thread starts at 5:00, (which sets SyncTS to 5:00). As explained above, the synchronization thread reads the first bit of the bitmap, reads the data associated with that bit (i.e., the first 4 blocks of the source virtual disk), sends that data to the target virtual disk, waits for a response, and clears the first bit. Because the synchronization timestamp Synch Ts is set to 5:00, the ordTs and ValTs of the first 4 blocks on the target virtual disk will be set to 5:00. FIG. 9 shows the source virtual disk and the target virtual disk after the synchronization thread processes the first bit.

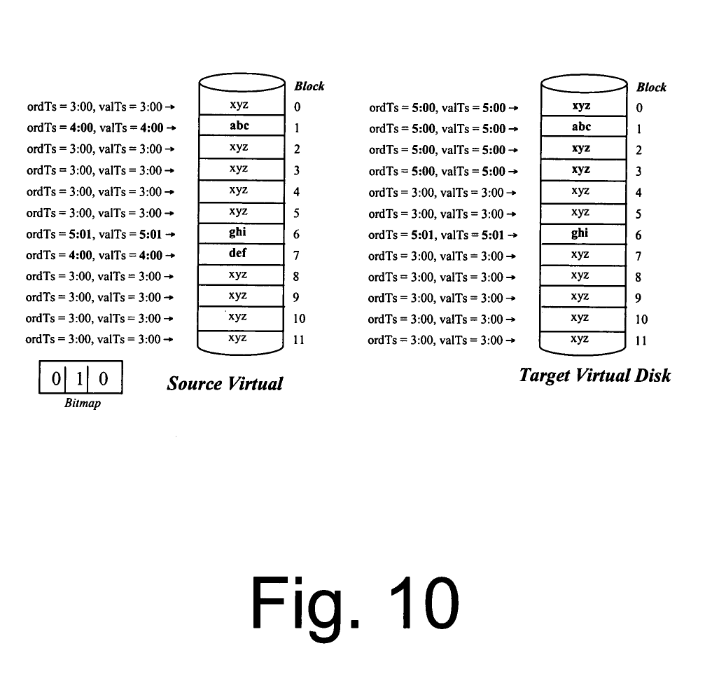

If, at 5:01, a host writes to block 6 of the source virtual disk while the synchronization thread is processing the first bit (that is, before the synchronization thread processes the bit associated with blocks 4 through 7). As explained above, the source controller will write to both the source virtual disk and the target virtual disk, resulting in the ordTs and the valTs of both systems being set to 5:01. FIG. 10 shows the source virtual disk and the target virtual disk after the entire write operation completes.

Next, the synchronization thread processes bit 2. When it does that, it will attempt to write blocks 4 through 7 to the target virtual disk with a timestamp of 5:00 (that is, the value of SyncTS). But, the order phase will fail, because block 6 on the target virtual disk has an ordTs of 5:01. So, because a host wrote to a smaller region than that of the synchronization thread, blocks 4, 5, and 7 may not be properly updated on the target virtual disk.

To address this issue, the high-level algorithm at the target storage cell for write requests received from the synchronization thread differs from the high-level algorithm for write requests received via normal synchronous replication (see Table 4). In one embodiment, when the target storage cell gets a write request from the synchronization thread, it performs the order phase of the write operation using the synchronization timestamp Synch TS. If that fails, then the target virtual disk has been modified by a write request that occurred after Synch TS. As shown in Table 4, the target storage cell cannot tell which blocks have been modified. To address this issue, it does the following:

a. It breaks up the write request into 1 block units, and performs the order phase (using SyncTS) on each 1 block unit.

b. If the order phase fails, it continues onto the next block (because the data on the current block has been modified by a later write request).

c. If the order phase succeeds, it issues the write phase on that 1 block unit.

d. If the write phase fails, it continues onto the next block, since the data on the current block has been modified by a write request that occurred after the order phase.

2. If the order phase in Step 1 succeeds, it performs the write phase. If the write phase fails, then one or more of the blocks were modified by a write request that arrived after the order phase completed. So, it performs steps a through d above.

Table 5 presents pseudocode for the actions listed above when the target storage cell gets a message from the synchronization thread.

TABLE 5

```
read resyncTs and the data from source storage cell;
status = moduleLocal.Order(resyncTs);
if (status = success) {
  status = moduleLocal.Write(resyncTs, data);
}
if (status == failure) {
  for (i = 0; i < number of blocks represented by a bit; i++) {
    // issue the order and write phase for a single block
    newstatus = moduleLocal.Order(resyncTs);
    if (newstatus == success)
        moduleLocal.Write(resyncTs, data for block i);
  }
}
return
```

Therefore, by following the algorithm in Table 5, the target storage cell would do the following when it received the write request from the synchronization thread for Blocks 4, 5, 6, and 7:

1. It issues the order phase for the entire data with a timestamp of 5:00.

2. The order phase fails because block 6 has an ordTs of 5:01

3. Because the order phase failed, it issues an order phase and a write phase for all four blocks. For example, it may perform the following operations:

a. Issues an order phase for block 4 with a timestamp of 5:00. Because the ordTs of that block is 3:00, the order phase succeeds and updates the ordTs to 5:00.

b. Issue a write phase of block 4 with the timestamp of 5:00. Because the valTs is 3:00, the write phase succeeds, the data is written to the block, and valTs is set to 5:00.

c. Issue an order phase for block 5 with a timestamp of 5:00. Because the ordTs of that block is 3:00, the order phase succeeds and updates the ordTs to 5:00.

d. Issue a write phase of block 5 with the timestamp of 5:00. Because the valTs is 3:00, the write phase succeeds, the data is written to the block, and valTs is set to 5:00.

e. Issue the order phase for block 6. However, that fails because the ordTs of block 6 is greater than 5:00. So, it proceeds to the next block.

f. Issue an order phase for block 7 with a timestamp of 5:00. Because the ordts of that block is 3:00, the order phase succeeds and updates the ordTs to 5:00.

9. Issue a write phase of block 7 with the timestamp of 5:00. Because the valTs is 3:00, the write phase succeeds, the data is written to the block, and valTs is set to 5:00.

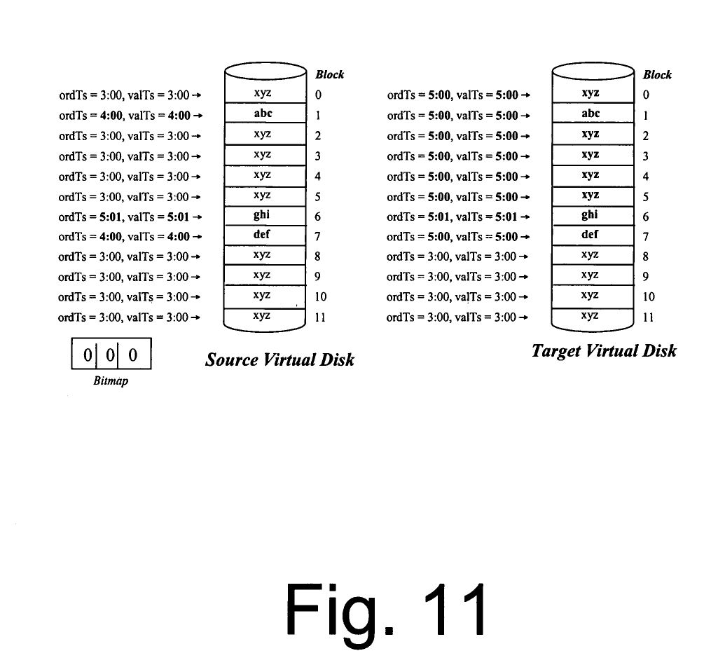

FIG. 11 is an illustration of the source volume and the target volume after processing. Breaking up a large write request into smaller write requests may be time consuming, but it only affects the synchronization thread, not the write requests from hosts.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method for bitmap based synchronization of a source volume and a target volume, comprising:
obtaining, in a source controller, a synchronization timestamp; and
for one or more bits in a bitmap representing the source volume:
transmitting a synchronization request to the target volume, wherein the synchronization request comprises the synchronization timestamp;
receiving a reply from the target volume; and
clearing the bit in the bitmap in response to the reply from the target volume.

2. The method of claim 1, wherein the synchronization timestamp represents a time at which synchronization is initiated.

3. The method of claim 1, further comprising transmitting with the synchronization request one or more data blocks associated with a bit in the bitmap.

4. The method of claim 1, further comprising:
receiving the synchronization request at the target volume; and
authorizing a synchronization write operation at the target volume when the synchronization timestamp received with the synchronization request is more recent in time than a timestamp associated with a corresponding data block in the target volume.

5. The method of claim 4, further comprising:
executing the synchronization write operation that writes data from the source volume to the target volume.

6. The method of claim 1, further comprising:
receiving the synchronization request at the target volume; and
performing a block-by-block timestamp comparison at the target volume when the synchronization timestamp received with the synchronization request is older in time than a timestamp associated with a corresponding data block in the target volume.

7. The method of claim 6, further comprising:
executing a synchronization write operation on a data block in the target volume that writes data from a specific block in the source volume to a corresponding block in the target volume.

8. A first storage controller, comprising:
a first I/O port that provides an interface to a host computer;
a second I/O port that provides an interface a storage device;
a first processor that receives I/O requests generated by the host computer and, in response to the I/O requests, generates and transmits I/O requests to the storage device; and
a memory module communicatively connected to the processor and comprising logic instructions which, when executed by the first processor, configure the first processor to:
obtain a synchronization timestamp; and
for one or more bits in a bitmap representing the source volume:
transmit a synchronization request to a target volume, wherein the synchronization request comprises the synchronization timestamp;
receive a reply from the target volume; and
clear the bit in the bitmap in response to the reply from the target volume.

9. The storage controller of claim 8, wherein the synchronization timestamp represents a time at which synchronization is initiated.

10. The storage controller of claim 8, further comprising logic instructions which, when executed by the processor, configure the first processor to transmit with the synchronization request one or more data blocks associated with a bit in the bitmap.

11. The storage controller of claim 8, further comprising a second storage controller coupled to the target volume and comprising:
a third I/O port that provides an interface to a host computer;
a fourth I/O port that provides an interface a storage device;
a second processor that receives I/O requests generated by the host computer and, in response to the I/O requests, generates and transmits I/O requests to the storage device; and
a memory module communicatively connected to the processor and comprising logic instructions which, when executed by the second processor, configure the second processor to:
receive the synchronization request at the target volume; and
authorize a synchronization write operation at the target volume when the synchronization timestamp received with the synchronization request is more recent in time than a timestamp associated with a corresponding data block in the target volume.

12. The storage controller of claim 11, further comprising logic instructions which, when executed by the second processor, configure the second processor to:
execute, in the second storage controller, the synchronization write operation that writes data from the source volume to the target volume.

13. The storage controller of claim 11, further comprising logic instructions which, when executed by the second processor, configure the second processor to:
receive the synchronization request at the target volume; and
perform a block-by-block timestamp comparison at the target volume when the synchronization timestamp received with the synchronization request is older in time than a timestamp associated with a corresponding data block in the target volume.

14. The storage controller of claim 11, further comprising logic instructions which, when executed by the second processor, configure the second processor to execute a synchronization write operation on a data block in the target volume that writes data from a specific block in the source volume to a corresponding block in the target volume.

15. A storage network, comprising:
a first storage cell comprising a first storage controller coupled to a first storage pool; and
a second storage cell comprising a second storage controller coupled to a second storage pool;
wherein the first storage cell comprises:
a first I/O port that provides an interface to a host computer;
a second I/O port that provides an interface a storage device;
a first processor that receives I/O requests generated by the host computer and, in response to the I/O requests, generates and transmits I/O requests to the storage device; and
a memory module communicatively connected to the processor and comprising logic instructions which, when executed by the first processor, configure the first processor to:
obtain a synchronization timestamp; and
for one or more bits in a bitmap representing a source volume:
transmit a synchronization request to a target volume in the second storage cell, wherein the synchronization request comprises the synchronization timestamp;
receive a reply from the target volume; and
clear the bit in the bitmap in response to the reply from the target volume.

16. The storage network of claim 15, wherein the memory module of the first storage cell further comprising logic instructions which, when executed by the processor, configure the first processor to transmit with the synchronization request one or more data blocks associated with a bit in the bitmap.

17. The storage network of claim 15, wherein the second storage cell comprises:
a third I/O port that provides an interface to a host computer;
a fourth I/O port that provides an interface a storage device;
a second processor that receives I/O requests generated by the host computer and, in response to the I/O requests, generates and transmits I/O requests to the storage device; and
a memory module communicatively connected to the processor and comprising logic instructions which, when executed by the second processor, configure the second processor to:
receive the synchronization request at the target volume; and
authorize a synchronization write operation at the target volume when the synchronization timestamp received with the synchronization request is more recent in time than a timestamp associated with a corresponding data block in the target volume.

18. The storage network of claim 17, further comprising logic instructions which, when executed by the second processor, configure the second processor to:
execute, in the second storage controller, the synchronization write operation that writes data from the source volume to the target volume.

19. The storage network of claim 17, further comprising logic instructions which, when executed by the second processor, configure the second processor to:
receive the synchronization request at the target volume; and
perform a block-by-block timestamp comparison at the target volume when the synchronization timestamp received with the synchronization request is older in time than a timestamp associated with a corresponding data block in the target volume.

20. The storage network of claim 15, further comprising logic instructions which, when executed by the second processor, configure the second processor to execute a synchronization write operation on a data block in the target volume that writes data from a specific block in the source volume to a corresponding block in the target volume.
